(19) United States
(12) Patent Application Publication
(10) Pub. No.: US 2007/0170670 A1
(43) Pub. Date: Jul. 26, 2007

(54) Bagger apparatus

(76) Inventor: Robert F. Mater JR., Elkhart, IN (US)

Correspondence Address: KING & SCHICKLI, PLLC, 247 NORTH BROADWAY, LEXINGTON, KY, 40507, US

(21) Appl. No.: 11/651,717

(22) Filed: Jan. 10, 2007

Related U.S. Application Data
(60) Provisional application No. 60/757,584, filed on Jan. 10, 2006.
(60) Provisional application No. 60/757,585, filed on Jan. 10, 2006.

(51) Int. Cl. B62B 1/00

(52) U.S. Cl. 280/47.19

(57) ABSTRACT

An apparatus is provided for holding a trash bag. The apparatus includes a base having a bottom wall, a first sidewall and a second sidewall. A bail is connected to the first and second sidewalls. A clip secures the trash bag to the bail.

This application claims the benefit of U.S. Provisional Patent Application Ser. Nos. 60/757,584 and 60/757,585, both filed on 10 Jan. 2006.

### TECHNICAL FIELD

The present invention relates generally to the trash bag field and, more particularly, to an apparatus for holding a trash bag open to allow more convenient introduction of trash and debris into the bag.

### BACKGROUND OF THE INVENTION

Home and garden maintenance often requires individuals to sweep or rake up grass clippings, leaves, dirt or other debris. Typically this material is raked into a pile before being placed into a plastic trash bag for disposal. Often such an individual works alone. It is generally difficult and time consuming to hold a trash bag open while placing dirt or debris therein. The present invention relates to an apparatus particularly adapted for holding a trash bag open to receive dirt and debris in a convenient, effective and efficient manner.

### SUMMARY OF THE INVENTION

In accordance with the purposes of the present invention as described herein, an apparatus is provided for holding a trash bag. The apparatus comprises a base including a bottom wall, a first sidewall and a second sidewall, a bail connected to the first and second sidewalls and a clip securing the trash bag to the bail. The apparatus may further include a resilient lip on the base. Further, the bottom wall of the apparatus may be stepped. In addition, the apparatus further includes a first pivot pin and a second pivot pin for connecting the bail to the base.

Still further, the apparatus may include a wall mounting bracket. That wall mounting bracket may include a slot for engaging at least one of the first pivot pin and a second pivot pin. Further, the apparatus may include a first shoulder connected to the first sidewall and a second shoulder connected to the second sidewall. In addition, the bail is displaceable between a storage position and a bag engaging position engaging the first and second shoulders.

In accordance with additional aspects of the present invention, the apparatus for holding a trash bag comprises a base, a bail connected to the base and means for securing to a wall. Further, the invention may include a method for improving a trash bag holder. The method comprises providing the trash bag holder with a structure for holding the trash bag open when the holders is positioned substantially horizontal to the ground or for when the trash bag holder is hanging substantially vertically on a wall.

In accordance with yet another embodiment, the apparatus for holding a trash bag comprises a base including a bottom wall, a first sidewall and a second sidewall, a bail pivotally connected to the first and second sidewalls, at least one resilient tab carried on the bail and at least one cooperating latching slot carried on one of the first and second sidewalls whereby the bail is locked into a bag retaining position by engagement of the resilient tab in the latching slot. In this embodiment the bail includes a bag retaining flange. The bag retaining flange includes rounded edges. Further, the bag retaining flange depends from the bail at an angle of about 90°.

Still further, the apparatus includes a cart. The cart includes a frame and wheels carried on the frame. The base is connected to the frame. The cart includes a pair of handles and a ramp between the handles.

In the following description there is shown and described several preferred embodiments of this invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING FIGURES

The accompanying drawings incorporated in and forming a part of the specification illustrate several aspects of the present invention, and together with the description serve to explain certain principles of the invention. In the drawings:

FIG. 1 is a perspective view of the apparatus of the present invention;

FIG. 2 is a perspective view showing a trash bag secured to the apparatus;

FIG. 3 is a perspective view showing the apparatus holding a trash bag and mounted to the wall of a building;

FIG. 4 is a detailed front elevational view showing connection between the base of the apparatus and a wall mounting bracket;

FIG. 5 is a perspective view of an alternative embodiment of the apparatus of the present invention;

FIG. 6 is a perspective view showing a trash bag secured to the apparatus of FIG. 5 while it is resting on the ground;

FIG. 7 is a perspective view showing the apparatus of FIG. 5 holding a trash bag and mounted to the wall of a building;

FIGS. 8a and 8b are detailed, partially sectional and front elevational views illustrating the spring locking mechanism between the bail and the base of the apparatus of FIG. 5; and

FIG. 9 is a perspective view showing the apparatus of FIG. 5 of the present invention connected to a wheeled cart.

Reference will now be made in detail to the present preferred embodiment of the invention, an example of which is illustrated in the accompanying drawings.

### DETAILED DESCRIPTION OF THE INVENTION

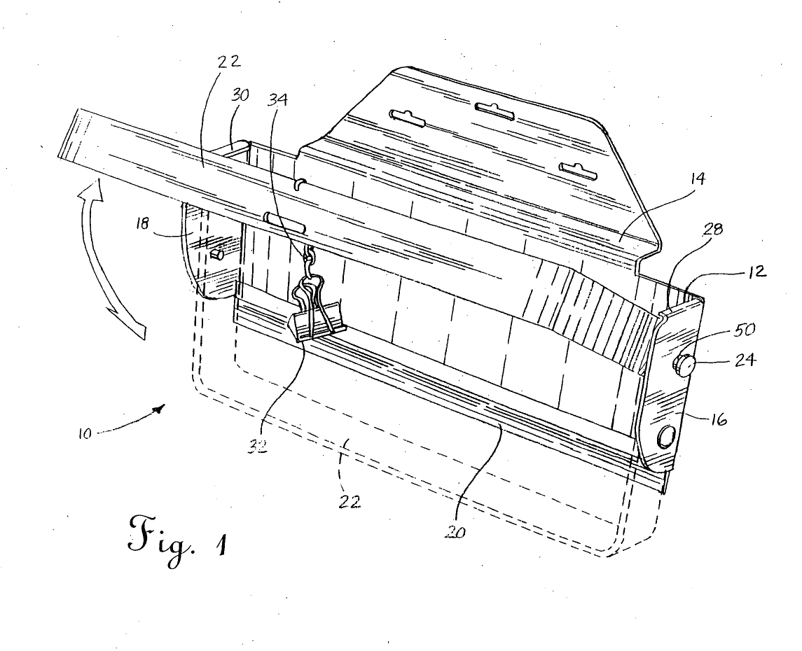

Reference is now made to FIG. 1 illustrating the apparatus 10 of the present invention for holding a trash bag. The apparatus 10 includes a base 12 having a stepped bottom wall 14, a first sidewall 16 and a second sidewall 18. A resilient lip 20 of rubber or other appropriate material is carried by the bottom wall 14.

A bail 22 is pivotally connected to the base 12. More specifically, a first end of the bail 22 is connected by a pivot pin 24 to the first sidewall 16 while a second end of the bail is connected by a pivot pin 26 to the second sidewall 18. In the illustrated embodiment the bail 22 is selectively displaceable between a storage position wherein the bail lays down approximately parallel to the bottom wall 14 over the resilient lip 20 (as illustrated in phantom line in FIG. 1) and a bagging or bag engaging position wherein the bail projects upwardly from the bottom wall 14 (as illustrated in full line in FIG. 1). When in the bagging position the bail engages a first shoulder 28 provided on the first sidewall 16 and a second shoulder 30 provided on the second sidewall 18. A fastening clip 32 is carried on the bail 22. In the illustrated embodiment the fastening clip 32 is connected to the bail by means of a short chain 34 so as to prevent it from becoming separated from the device and lost.

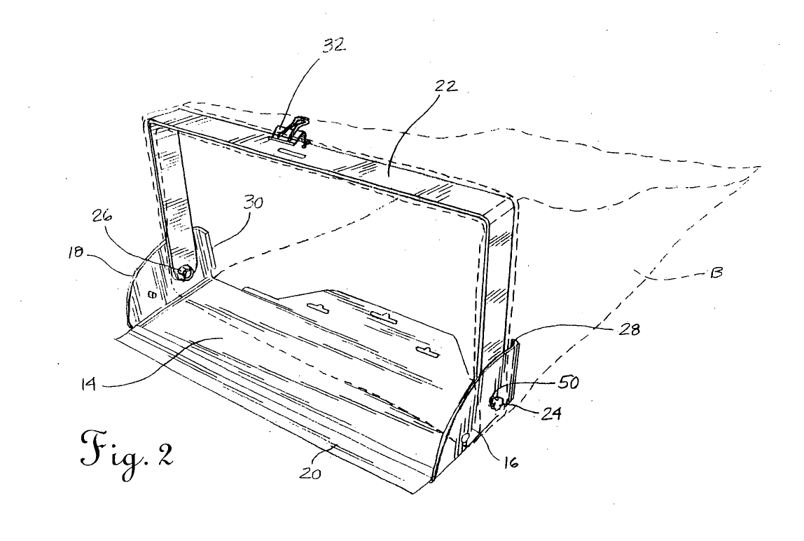

As illustrated in FIG. 2, the apparatus 10 of the present invention may be utilized to hold the trash bag B open when the bottom wall 14 of the base 12 is resting on the ground. More specifically, first the bail 22 is raised into the bagging position so that the bail is engaging the first and second shoulders 28, 30. Next, the open end of a trash bag B is pulled over the stepped end 36 of the bottom wall 14 projecting away from the resilient lip 20, the rearward end of the first and second sidewalls 16, 18 and the bail 22. The trash bag B is stretched slightly to extend over these structures thereby providing frictional engagement that tends to hold the trash bag in position. The clip 32 positively secures the connection by holding the trash bag B tightly to the bail 22.

With the bottom wall 14 resting on the ground, dirt and debris including leaves, grass clippings and the like may be easily raked or swept into the trash bag B by passing up the resilient lip 20 and over the bottom wall 14 under the bail 22 into the interior of the trash bag B.

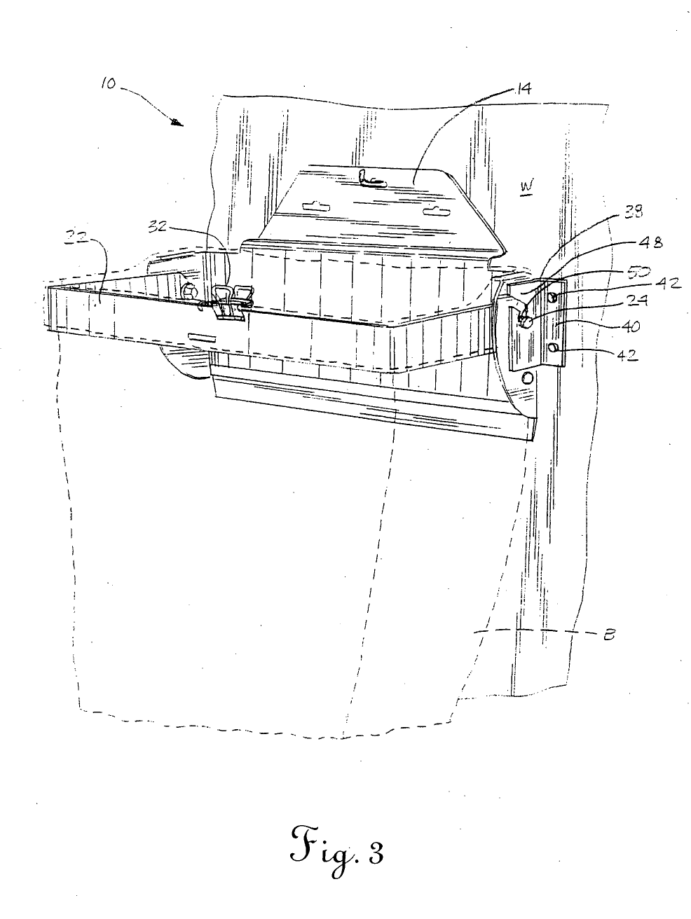

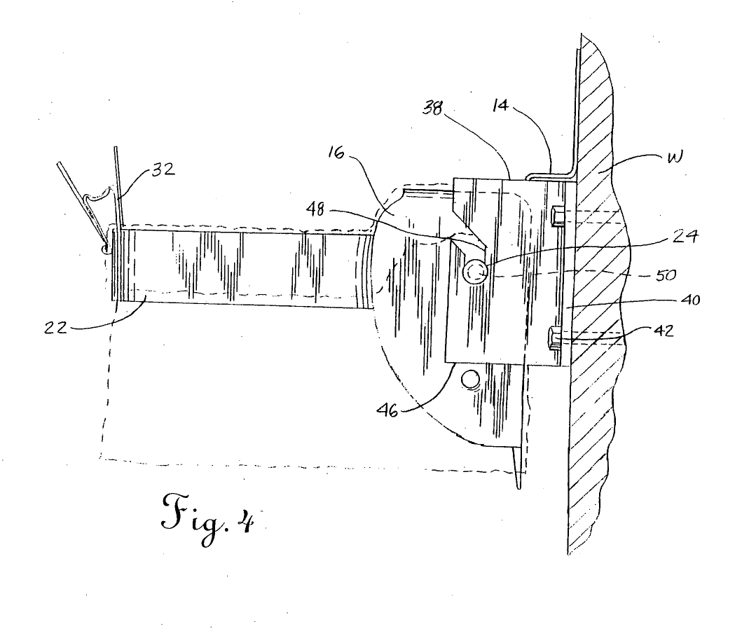

In accordance with an additional aspect of the present invention, the apparatus 10 may also be hung vertically from a wall W (see FIGS. 3 and 4). More specifically, a wall mounting bracket is provided. The wall mounting bracket 38 includes a body of substantially L shape having a first section 40 including apertures for receiving fasteners 42 (e.g. screws or nails) for securing the bracket 38 to the wall. A second section 46 of the body projects from the first section 41 and the wall W. The second section includes a slot 48.

The head of the pivot pin 24 and the head of the pivot pin 26 both include a groove 50 that is freely received in the slot 48 of the bracket 38. Thus, by spacing two brackets 38 along the wall W at an appropriate distance, the groove 50 of the first pivot pin 24 is received in the slot 48 on the first bracket 38 while the groove 50 in the second pivot pin 26 is received in the slot 48 on the second bracket 38. In this way the apparatus 10 may be hung from the wall W with a bag connected as illustrated in FIGS. 3 and 4. Thus, the trash bag B is held open to receive dirt and debris.

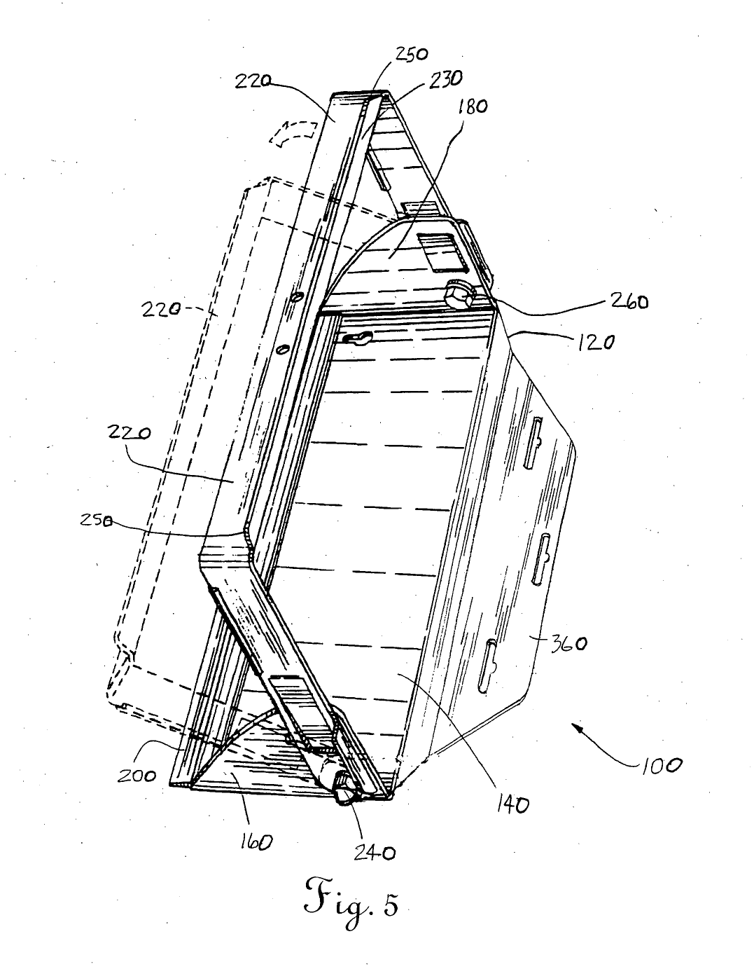

Reference is now made to FIG. 5 illustrating an alternative embodiment of the apparatus 100 of the present invention for holding a trash bag. The apparatus 100 includes a base 120 having a stepped bottom wall 140, a first sidewall 160 and a second sidewall 180. A resilient lip 200 of rubber or other appropriate material is carried by the bottom wall 140.

A bail 220 is pivotally connected to the base 120. More specifically, a first end of the bail 220 is connected by a bolt or pivot pin and cooperating acorn nut 240 to the first sidewall 160 while a second end of the bail is connected by a bolt or pivot pin and cooperating acorn nut 260 to the second sidewall 180. In the illustrated embodiment the bail 220 is selectively displaceable between a bagging or bag engaging position wherein the bail projects upwardly from the bottom wall 140 at an angle of approximately 90° (as illustrated in full line in FIG. 5) and a storage or bag loading position wherein the bail lays down at an acute angle to the bottom wall 140 (as illustrated in phantom line in FIG. 5).

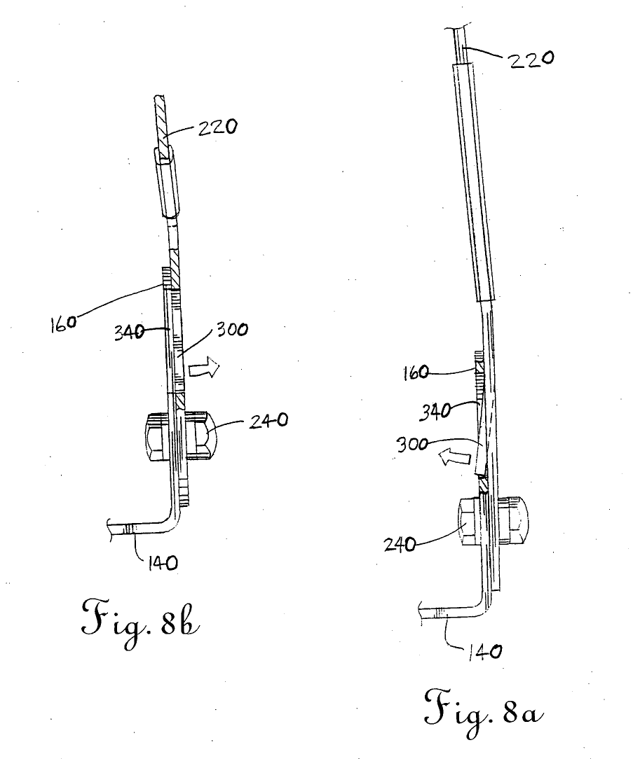

As best illustrated in FIGS. 5, 8a and 8b, the bail 220 includes a resilient retaining tab 300 provided adjacent each end thereof. Each retaining tab 300 may be formed integrally with the bail 200 by cutting along three sides and bending along the fourth side 320. When the bail 220 is in the bag retaining position, each retaining tab 300 is biased (note action arrow in FIG. 8a) by the resilient memory of the bent fourth side 320 into a cooperating latching slot 340 formed in the adjacent sidewall 160, 180. The engagement of each retaining tab 300 in the cooperating slots 340 positively holds the bail 220 in the bag retaining position. The bail 220 may only be moved out of the bag retaining position by pressing each retaining tab 300 in the direction of the action arrow in FIG. 8b until the tabs clear the slots 340 thereby freeing the bail to be pivoted to another position.

A bag retaining flange 230 depends from the bail 220. The flange 230 extends at a right angle to the bail 220 to help stretch the bag B and secure it to the device 100 as the bail is moved into the bag retaining position. The corners of the flange 230 are rounded to prevent tearing the bag.

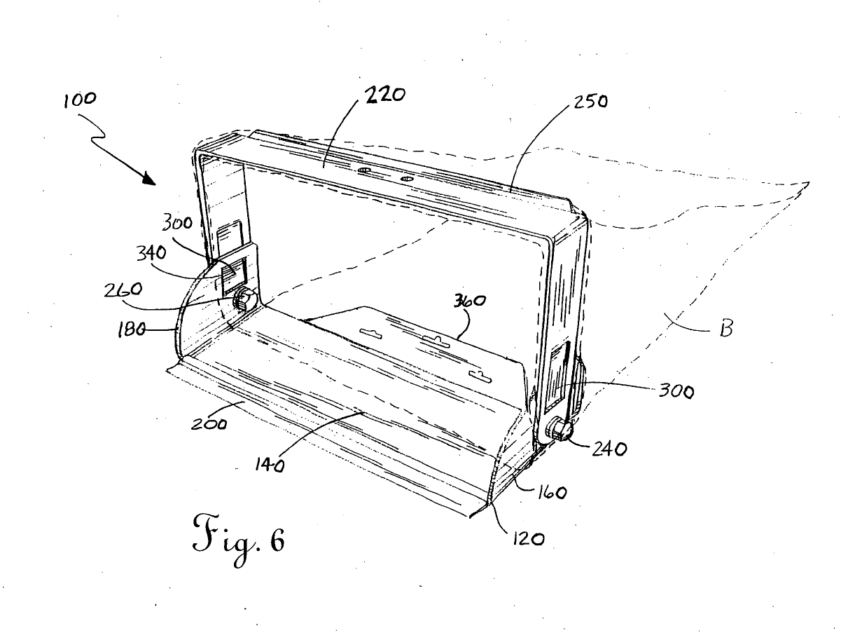

As illustrated in FIG. 6, the apparatus 100 of the present invention may be utilized to hold the trash bag B open when the bottom wall 140 of the base 120 is resting on the ground. More specifically, first the open end of a trash bag B is pulled over the stepped end 360 of the bottom wall 140 projecting away from the resilient lip 200, the rearward end of the first and second sidewalls 160, 180 and the bail 220 which is initially in the storage or bag loading position resting at an acute angle to the bottom wall. Next, the bail 220 is raised into the bag retaining position illustrated in FIG. 6. As this is done, the bail 220 stretches the bag B tight over the acorn nuts 240, 260 and base 120 thereby securely holding it in an open position. Further, the bail 220 is positively retained in the raised, bag retaining position by the resilient action of the tabs 300 which are biased into locking engagement in the slots 340 of the sidewalls 160, 180.

With the bottom wall 140 resting on the ground, dirt and debris including leaves and the like may be easily raked or swept into the open trash bag B by passing up the resilient lip 200 and over the bottom wall 140 under the bail 220 into the interior of the trash bag B.

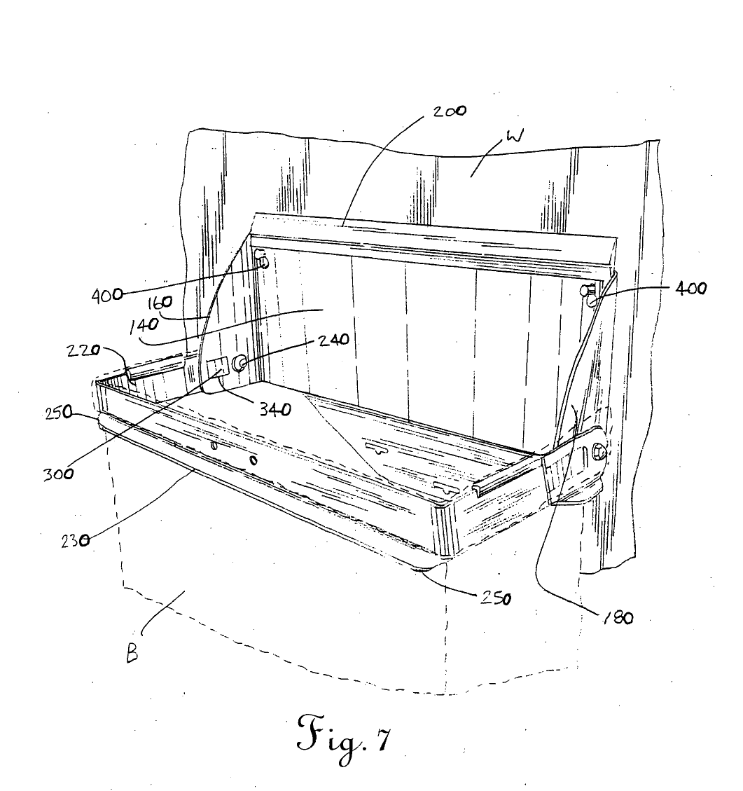

In accordance with an additional aspect of the present invention, the apparatus 100 may also be hung vertically from a wall W (see FIG. 7). More specifically, the base 120 includes at least two keyhole shaped apertures 400 adjacent the resilient lip 200. These keyhole shaped apertures 400 are received over and locked into engagement with two fasteners 420 (e.g. screws or nails) for securing the device 100 to the wall W.

The bag B is installed in the same way. First, the open end of the bag B is pulled over the end of the base 120 including the sidewalls 160, 180 and the acorn nuts 240, 260 as well as the bail 200 which is lowered and resting substantially parallel to the bottom wall 140. The bail 220 is then raised into the bag retaining position as illustrated. As the bail 220 is raised, the bag is stretched and thereby secured to the device 100. The bail 220 is then locked into position by engagement of the resilient tabs 300 into the cooperating slots 340 in the sidewalls 160, 180.

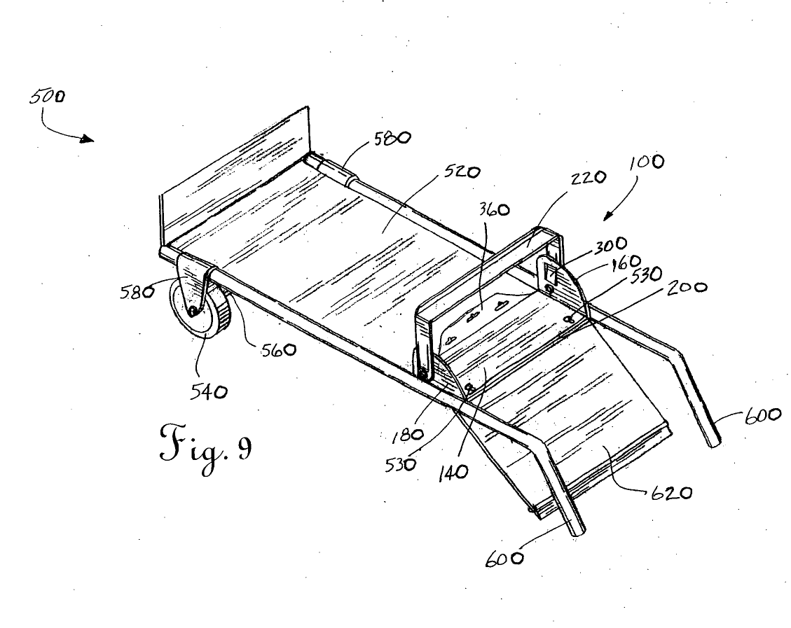

As further illustrated in FIG. 9, the apparatus 100 of the present invention may be connected to a wheeled cart, generally designated by reference numeral 500. The wheeled cart 500 includes a base or frame 520 to which the apparatus 100 is connected by fasteners 530 such as screws. A pair of wheels 540 (only one is illustrated) are carried on an axle 560 connected to the base or frame 520 by means of brackets 580. A pair of handles 600 are provided at the opposite end of the base or frame 520. A ramp 620 extends between the handles 600.

A trash bag such as a large 55 gallon bag is positioned on the apparatus 100 using the bail 220 as described above. With the handles 600 resting on the ground, trash is raked or swept into the trash bag by traveling up the ramp 620 and over the bottom wall 140. When full, the handles are raised and the cart 500 is pushed to a desired location where the trash bag may be released from the apparatus 100 and the cart 500.

In summary, the present apparatus 10, 100 functions on the ground, a cart or a wall in either a substantially horizontal or substantially vertical position to hold a trash bag B open for receiving dirt and debris. Accordingly, the apparatus 10, 100 of the present invention is more versatile than trash bag holders of the prior art and represents a significant advance in the art.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiment do not and are not intended to limit the ordinary meaning of the claims and their fair and broad interpretation in any way.

What is claimed:

1. An apparatus for holding a trash bag, comprising:
a base including a bottom wall, a first sidewall and a second sidewall;
a bail connected to said first and second sidewalls; and
a clip securing the trash bag to said bail.

2. The apparatus of claim 1, further including a resilient lip on said base.

3. The apparatus of claim 1, wherein said bottom wall is stepped.

4. The apparatus of claim 1, further including a first pivot pin and a second pivot pin for connecting said bail to said base.

5. The apparatus of claim 1, further including a wall mounting bracket.

6. The apparatus of claim 5, wherein said wall mounting bracket includes a slot for engaging at least one of said first pivot pin and said second pivot pin.

7. The apparatus of claim 1, further including a first shoulder connected to said first sidewall and a second shoulder connected to said second sidewall.

8. The apparatus of claim 7, wherein said bail is displaceable between a storage position and a bag engaging position engaging said first and second shoulders.

9. An apparatus for holding a trash bag, comprising:
a base;
a bail connected to said base; and
means for securing to a wall.

10. The apparatus of claim 9, further including a trash bag clip carried on said bail.

11. The apparatus of claim 9, further including a resilient lip on said base.

12. A method of improving a trash bag holder, comprising:
providing said trash bag holder with a structure for holding the trash bag open when said holder is positioned substantially horizontally on the ground; and
providing said trash bag holder with a structure for holding the trash bag open when said trash bag holder is hanging substantially vertically on a wall.

13. An apparatus for holding a trash bag, comprising:
a base including a bottom wall, a first sidewall and a second sidewall;
a bail pivotally connected to said first and second sidewalls;
at least one resilient tab carried on said bail; and
at least one cooperating latching slot carried on one of said first and second sidewalls whereby said bail is locked into a bag retaining position by engagement of said resilient tab in said latching slot.

14. The apparatus of claim 13, further including a resilient lip on said base.

15. The apparatus of claim 13, wherein said bail includes a bag retaining flange.

16. The apparatus of claim 15, wherein said bag retaining flange includes rounded edges.

17. The apparatus of claim 16, wherein said bag retaining flange depends from said bail at an angle of about 90°.

18. The apparatus of claim 13, further including a cart.

19. The apparatus of claim 18, wherein said cart includes a frame and wheels carried on said frame.

20. The apparatus of claim 19, wherein said base is connected to said frame.

21. The apparatus of claim 20, wherein said cart includes a pair of handles and a ramp between said handles.

22. The apparatus of claim 21, wherein said ramp is aligned with said bottom wall.
